(19) United States
(12) Patent Application Publication
(10) Pub. No.: US 2026/0065882 A1
(43) Pub. Date: Mar. 5, 2026

(54) MUSICAL INSTRUMENT CASE

(71) Applicant: Lee Oskar LEVITIN, Everett, WA (US)

(72) Inventor: Lee Oskar LEVITIN, Everett, WA (US)

(21) Appl. No.: 18/821,305

(22) Filed: Aug. 30, 2024

(51) Int. Cl. G10G 7/00

(52) U.S. Cl. CPC G10G 7/005

(57) ABSTRACT

An instrument case including a housing having longitudinal axis, wherein the housing defines an instrument accommodation space and wherein the housing includes an opening at each longitudinal end of the housing. End caps are operable to close the openings at each longitudinal end of the housing. The end caps each have a respective connector, wherein the end caps are releasably attached to each end of the housing via the respective connectors.

### BACKGROUND OF THE DISCLOSURE

### 1. Field of the Disclosure

The present disclosure relates to a musical instrument case, and more specifically relates to a weather-resistant musical instrument case.

### 2. Background of the Disclosure

Research has established that studying music enhances academic achievement including areas of mathematics, science, geography, history, foreign language, physical education, and vocational training. For example, studies have shown that students with piano or keyboard experience performed 34% higher on tests that measure spatial-temporal lobe activity, which is the part of the brain that is used when doing mathematics, science, and engineering.

Studies have shown that music education can be used to enhance cognitive achievement in students. When a student is singing a melody with text, they are using multiple areas of their brain to multitask. Music positively impacts language development, increases IQ (Intelligence Quotient), spatial-temporal skills, and improves test scores. For example, music education has also been noted to have the ability to increase someone's overall IQ, especially in children during peak development years. Spatial ability, verbal memory, reading and mathematical ability are seen to be increased alongside music education (primarily through the learning of an instrument). Researchers also note that a correlation between general attendance and IQ increases is evident, and due to students'involvement in music education, general attendance rates increase along with their IQ. Fine motor skills, social behaviors, and emotional well-being can also be increased through music and music education. The learning of an instrument increases fine motor skills in students with physical disabilities. Emotional well-being can be increased as students find meaning in songs and connect them to their everyday life. Through social interactions of playing in groups like jazz and concert bands, students learn to socialize, and this can be linked to emotional and mental well-being.

Thus, the benefits of incorporating music, and specifically music making, on a person's well-being is well established. While these benefits of music making are clear, there are still many individuals who never learn or attempt to learn how to make music. For example, while a campfire environment may be an ideal setting for making music, some potential players may be reluctant to carry an instrument (e.g., a harmonica) to such a setting for fear of exposing their instrument to potentially damaging elements (e.g., water, sand, etc.)

Thus, there is a need for an improved musical instrument case with the ability to protect an instrument (e.g., a harmonica) from such potentially damaging elements (e.g., water, sand, etc.).

### SUMMARY OF THE EMBODIMENTS OF THE DISCLOSURE

Aspects of the disclosure are directed to a musical instrument case. The instrument case includes a housing having longitudinal axis, wherein the housing defines an instrument accommodation space and wherein the housing includes an opening at each longitudinal end of the housing. End caps operable to close the openings at each longitudinal end of the housing. The end caps each have a respective connector, wherein the end caps are releasably attached to each end of the housing via the respective connectors.

In embodiments, the housing further comprises a projection extending from each end of the housing; and an attachment loop extending between the projections. The projections and the attachment loop define a slot on a side of the instrument case.

In further embodiments, the housing further comprises a bearing defining an eyelet.

In additional embodiments, the bearing is connected with one of the projections.

In yet additional embodiments, the housing further comprises for each end cap, an attachment/vent hole and a recess.

In embodiments, the recess is sized to accommodate the respective connector.

In further embodiments, each end cap includes a protrusion arranged on the connector, and the attachment/vent hole is sized to fasteningly accommodate the protrusion.

In embodiments, the attachment/vent hole has an oblong shape.

In further embodiments, the housing further comprises an end flange on each longitudinal end of the housing, wherein each end flange is sized to accommodate one of the end caps on an external surface thereof.

In additional embodiments, each end cap includes a depression on an inner surface of the end cap. Each end flange includes a protruding lip, wherein the protruding lip is sized to sealingly engage with the depression on an inner surface of the end cap.

In yet additional embodiments, at least one of the end flanges includes at least one recessed region for providing gripping access.

In embodiments, each end flange includes a protruding lip, and the recessed region does not extend longitudinally inwardly beyond a longitudinally outward extent of the protruding lip.

In further embodiments, the housing further comprises a bearing defining an eyelet. The at least one recessed region is provided on a same end of the housing as the bearing defining the eyelet.

In embodiments, when the end cap is closed on the flange while the protrusion is removed from the attachment/vent hole, the attachment/vent hole is operable as a vent for an interior of the instrument case.

In further embodiments, when each of the end caps is closed on each of the flanges, the protruding lips engage with the depressions on the interiors of end caps to seal the instrument case from an outside environment.

In additional embodiments, each longitudinal end portion of the housing includes a projection extending therefrom, wherein the projections are longitudinally inward of the end flanges.

In yet additional embodiments, when the end cap is attached and closed, and the protrusion is accommodated in the attachment/vent hole, the connector is accommodated in the recess such that an outer surface of the connecter is flush with an outer surface of the housing.

In embodiments, when the end cap is attached and open, the protrusion is retained in the attachment/vent hole so that the end cap remains securely attached to the housing.

In further embodiments, each end cap is operable to swingably move away from the housing via an elastic deformation of the connector to provide user access to the instrument accommodation space.

In embodiments, the connector is retained via connection to the attachment/vent hole and is bendable outward from the recess so that the end cap can be removed from the flange and swung outwardly beyond a sliding range for an instrument in the instrument case to provide user access to the instrument or the instrument accommodation space.

In accordance with aspects of the disclosure, an instrument case having end caps to seal each end of the instrument case provides an improved musical instrument case with the ability to protect an instrument (e.g., a harmonica) from such potentially damaging elements (e.g., water, sand, etc.). By implementing aspects of the disclosure, a user can more easily protect their musical instrument and be more confident of such protection when in the “elements.” Thus, by implementing aspects of the disclosure, greater and more frequent usage of musical instruments in a wider variety of environments can be achieved. For example, by providing a secure instrument case, the fear of exposing an instrument to potentially damaging elements (e.g., water, sand, etc.) is reduced. As such, a user of the instrument case may be less reluctant to carry an instrument (e.g., a harmonica) to such a campfire environment setting—an ideal setting for making music

As such, by implementing aspects of the disclosure, many more people may more readily access and experience playing music, and thereby experience the resulting benefits of music making on their well-being.

In accordance with further aspects of the disclosure, the instrument case is designed to optimize instrument portability, protection, access, and care. For example, the instrument case is easy to carry, with a sturdy carabiner loop and belt loop for secure fastening. Additionally, the instrument case provides protection for the instrument. In embodiments, the housing may be constructed of impact-resistant rigid material (e.g., plastic, metal or composite material) and the end caps may be made of a relatively flexible material (e.g., plastic or rubber material). The instrument case protects against physical damage (e.g., sand, debris) and weather conditions (e.g., rain, humidity, other precipitation). The instrument case includes secure seals to protect the internal contents from water and sand exposure, and vents for airing out at either end (or both ends) of the instrument case.

In accordance with further aspects of the disclosure, the instrument case enables ambidextrous and adaptable access to the instrument. In an exemplary and non-limiting embodiment, the instrument case may be configured and operable to accommodate most 10-hole (e.g. diatonic) harmonicas.

In accordance with additional aspects of the disclosure, the materials used for both the housing and the end caps may be easy to clean and sanitize. For example, the material used for the housing and/or the material used for the end caps may be dishwasher-safe. Additionally, the removable end caps allow the accommodation space of the housing to be easily accessed and quickly dried.

As such, by implementing aspects of the disclosure, an instrument case is optimizes instrument portability, protection, access, and care.

### BRIEF DESCRIPTION OF THE DRAWINGS

The novel features which are characteristic of the musical instrument case, both as to structure and method of operation thereof, together with further aims and advantages thereof, will be understood from the following description, considered in connection with the accompanying drawings, in which embodiments of the disclosure are illustrated by way of example. It is to be expressly understood, however, that the drawings are for the purpose of illustration and description only, and they are not intended as a definition of the limits of the disclosure. For a more complete understanding of the disclosure, as well as other aims and further features thereof, reference may be had to the following detailed description of the embodiments of the disclosure in conjunction with the following exemplary and non-limiting drawings, in which:

FIGS. 1A-1D show various views of an exemplary instrument case in accordance with aspects of the disclosure;

FIG. 2 shows a perspective view of an instrument case in accordance with aspects of the disclosure;

FIG. 3 shows a top view of an instrument case with both end caps removed and an instrument arranged therein in accordance with aspects of the disclosure;

FIG. 4 shows a perspective view of an instrument case with both end caps removed and an instrument arranged therein in accordance with aspects of the disclosure;

FIG. 5 shows another perspective view of an instrument case with both end caps removed and an instrument arranged therein in accordance with aspects of the disclosure;

FIGS. 6A and 6B show a perspective view and a top view of an instrument case with one end cap closed and one end cap opened and an instrument arranged therein in accordance with aspects of the disclosure; and

FIGS. 7A and 7B show a perspective view and a top view of an instrument case with one end cap closed and one end cap opened and an instrument partially arranged therein in accordance with aspects of the disclosure.

### DETAILED DESCRIPTION OF THE EMBODIMENTS OF THE DISCLOSURE

The novel features which are characteristic of the disclosure, both as to structure and method of operation thereof, together with further aims and advantages thereof, will be understood from the following description, considered in connection with the accompanying drawings, in which embodiments of the disclosure are illustrated by way of example. It is to be expressly understood, however, that the drawings are for the purpose of illustration and description only, and they are not intended as a definition of the limits of the disclosure.

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the embodiments of the present disclosure. In this regard, no attempt is made to show structural details of the embodiments of the present disclosure in more detail than is necessary for the fundamental understanding of the embodiments of the present disclosure. The description, taken with the drawings, makes apparent to those skilled in the art how the forms of the embodiments of the present disclosure may be embodied in practice.

As used herein, the singular forms “a,” “an,” and “the” include the plural reference unless the context clearly dictates otherwise. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e., the range from 95 to 105. Generally, when the terms “about” and “approximately” are used, it can be expected that similar results or effects according to the disclosure can be obtained within a range of ±5% of the indicated value.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

The term “substantially parallel” refers to deviating less than 20° from parallel alignment and the term “substantially perpendicular” refers to deviating less than 20° from perpendicular alignment. The term “parallel” refers to deviating less than 5° from mathematically exact parallel alignment. Similarly, “perpendicular” refers to deviating less than 5° from mathematically exact perpendicular alignment.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for example a composition comprising a compound A may include other compounds besides A. However, the term “comprising” also covers the more restrictive meanings of “consisting essentially of” and “consisting of”, so that for example “a composition comprising a compound A”may also (essentially) consist of the compound A.

The various embodiments disclosed herein can be used separately and in various combinations unless specifically stated to the contrary.

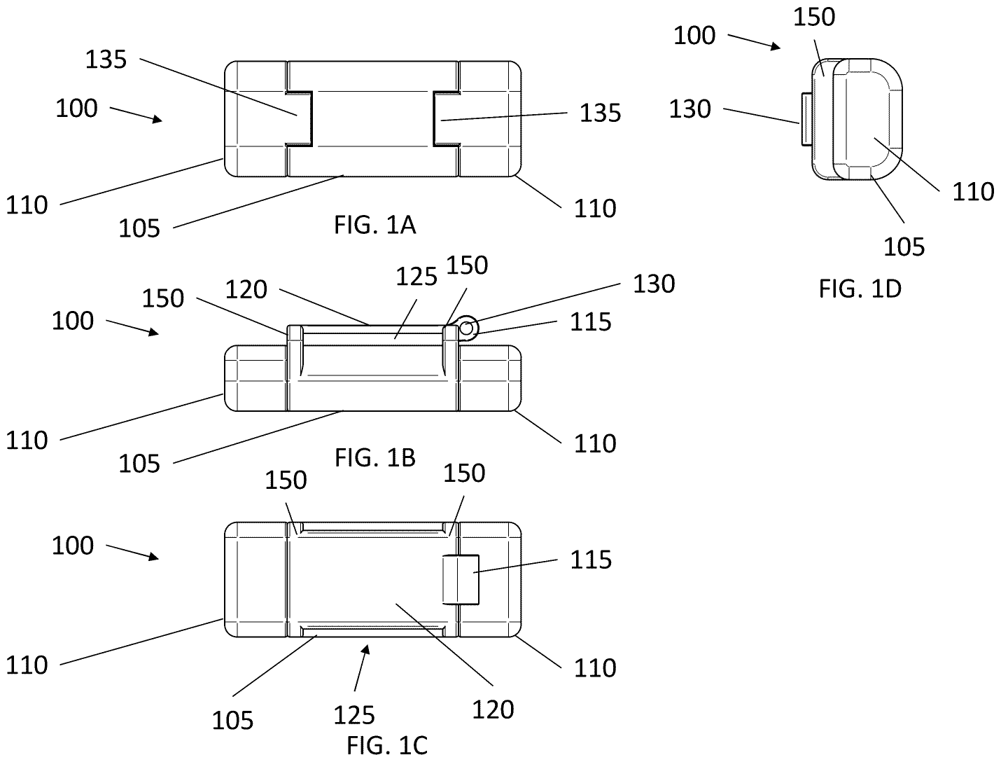

FIGS. 1A-1D show various views of an exemplary instrument case 100 in accordance with aspects of the disclosure. As shown in the top view of FIG. 1A, the instrument case 100 incudes a housing 105 and end caps 110 releasably attached to each end of the housing 105 via respective connectors 135. As shown in the side view of FIG. 1B, the bottom view of FIG. 1C, and the end view of FIG. 1D, the housing 105 includes two projections 150 that extend from each end of the housing 105, and an attachment loop 120 extending between the two projections 150 defining a slot 125 on a back side of the case 100. In accordance with aspects of the disclosure, a user may carry the instrument case 100 by passing their belt, for example, through the slot 125.

Additionally, as shown in FIG. 1B, with this exemplary embodiment, the housing 105 also includes a bearing 115 defining an eyelet 130. The bearing 115 may be connected with one of the projections 150. By connecting the bearing 115 with the projection 150, the bearing 115 and the projection 150 mutually support and reinforce each other. In accordance with aspects of the disclosure, a user may carry the instrument case 100 by passing a hook or a carabiner through the eyelet 130. In embodiments, the housing 105 may be constructed of impact-resistant rigid material (e.g., plastic, metal or composite material) and the end caps 110 may be made of a relatively flexible material (e.g., plastic or rubber material).

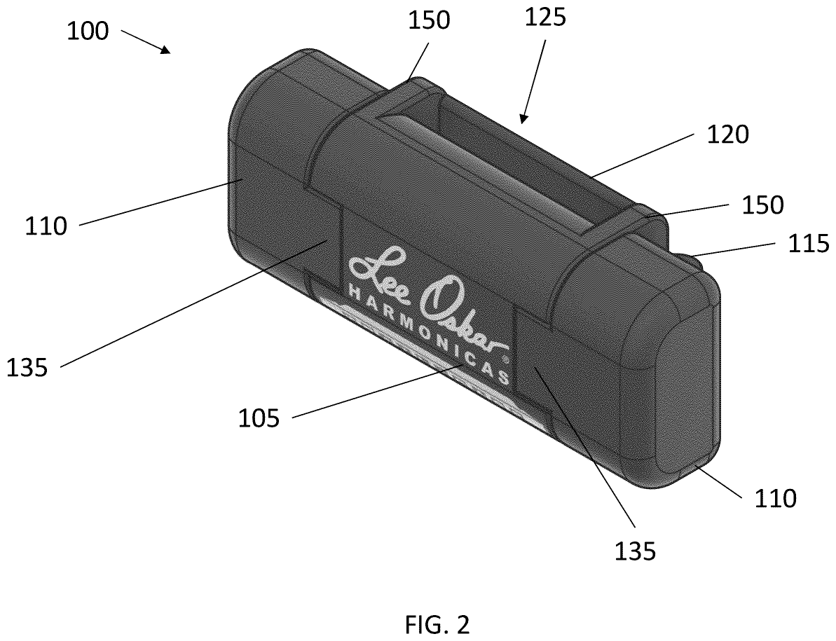

FIG. 2 shows a perspective view of an instrument case 100 in accordance with aspects of the disclosure. As shown in FIG. 2, the instrument case 100 incudes a housing 105 and end caps 110 releasably attached to each end of the housing 105 via respective connectors 135. As shown in the perspective view of FIG. 2, the housing 105 includes two projections 150 that extend from each end of the housing 105 and an attachment loop 120 extending between the two projections 150 defining a slot 125 on a back side of the case 100. Additionally, as shown in FIG. 2, with this exemplary embodiment, the housing 105 also includes a bearing 115 connected with one of the projections 150. In accordance with aspects of the disclosure, a user may carry the instrument case 100 by passing a hook or a carabiner, for example, through the eyelet 130 and/or a user may carry the instrument case 100 by passing their belt, for example, through the slot 125.

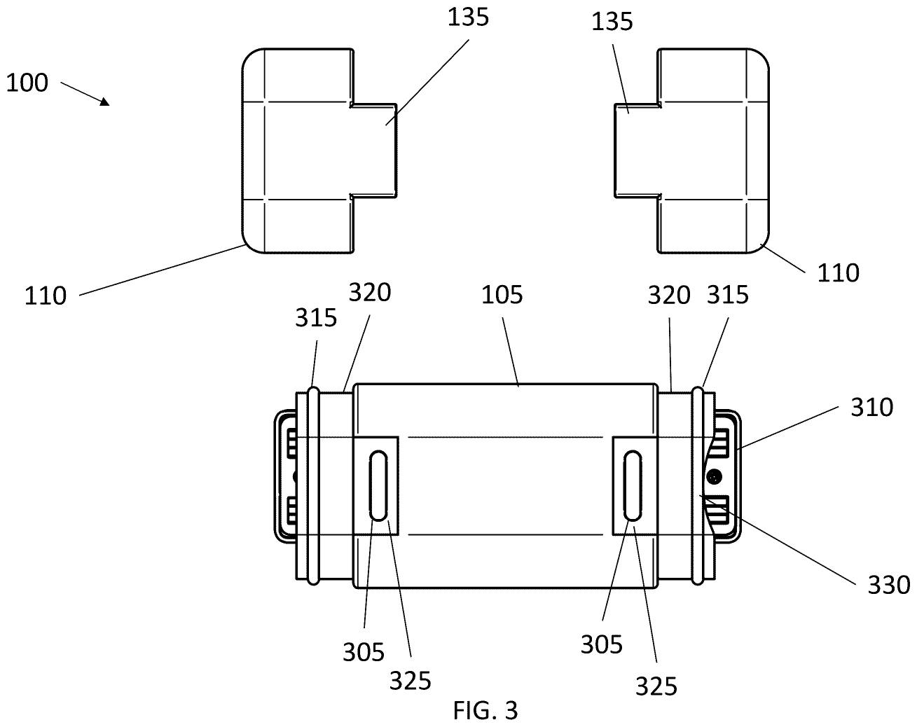

FIG. 3 shows a top view of an instrument case 100 with both end caps 110 removed and an instrument 310 arranged therein in accordance with aspects of the disclosure. As shown in FIG. 3, the housing 105 includes for each end cap 110, an attachment (or vent) hole 305 and a recess 325. The recess 325 is sized to accommodate the connector 135 of the end cap and the attachment (or vent) hole 305 is sized to accommodate (e.g., in a friction fit engagement) a protrusion (not shown) arranged on the connector 135 of the end cap 110. In the exemplary embodiment of FIG. 3, the attachment (or vent) hole 305 has an oblong shape. The disclosure, however, contemplates the attachment hole (or vent) 305 may have other shapes, such as circular, quadrilateral, polygonal, etc. Additionally, while the exemplary embodiment includes a single attachment (or vent) hole 305 for each end cap 110, the disclosure contemplates each end cap 110 may have more than one attachment (or vent) hole 305.

As described herein, the attachment (or vent) hole 305 is used to secure the end cap 110 via the connector 135. In accordance with additional aspects of the disclosure, however, the attachment (or vent) hole 305 is also configured to selectively function as a vent for the instrument case. For example, there may be instances when a user desires to remove moisture from the interior of the instrument case 100. In such an instance, a user can remove the protrusion from the attachment (or vent) hole 305 (e.g., while the end cap 110 remains secured to the housing 110 and the instrument remains secured therein) to open the vent hole 305 to expose the interior of the instrument case 100 to the outside environment. In such a manner, the attachment (or vent) hole 305 is operable to also function as a vent for the instrument case. Additionally, for example, a user could remove the protrusions from both of the attachment (or vent) holes 305 to open both vents and allow for a circulation of air flow through the instrument case 100. Thus, while aspects of the disclosure are directed to providing a weather-resistant case, it should be understood that further aspects of the present disclosure are directed to the selective venting of the instrument case.

As also shown in FIG. 3, the housing 105 includes an end flange 320 on each end of the housing 105. Each end flange 320 is sized to accommodate an end cap 105 on the external surface thereof. As shown in FIG. 3, each end flange 320 includes a protruding lip 315. The protruding lip 315 is sized to engage with a corresponding depression (not shown) on an inner surface of the end cap 110.

As shown in FIG. 3, the housing 105 is sized to accommodate a musical instrument 310. With the exemplary embodiment of FIG. 3, the housing is sized to accommodate a single harmonica musical instrument 310. The disclosure contemplates, however, the housing 105 may be sized to accommodate a plurality of harmonicas, a larger harmonica (e.g., a chromatic harmonica) or other musical instruments such as, kazoos, melodicas, or recorders, for example.

In embodiments, one or both of the end flanges 320 may include a recessed region 330 (e.g., a concavely-shaped recessed region) for providing access (e.g., griping access) for a user's fingers. In accordance with aspects of the disclosure, a user may more easily grip the musical instrument 310 by gripping in the recessed region 330. While the embodiment of FIG. 3 shows only one end of the housing 105 having the recessed region 330, it should be understood that in other contemplated embodiments, both ends of the housing 105 may include a recessed region 330. As shown in FIG. 3, the recessed region 330 does not extend beyond the protruding lip 315. In such a manner, as described further below, when the end cap 110 is closed on the flange 320, the protruding lip 315 engages with the corresponding depression (not shown) on the interior of end cap 110 to seal the end of the instrument case 100.

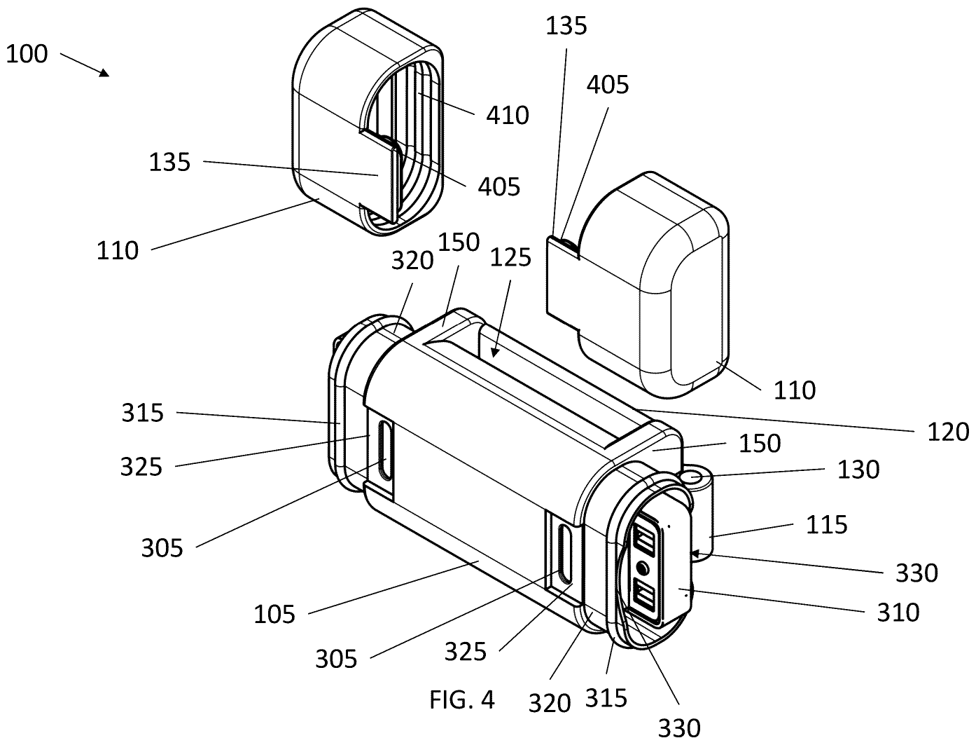

FIG. 4 shows a perspective view of the instrument case 100 with both end caps 110 removed from the housing 105 and an instrument 310 arranged therein in accordance with aspects of the disclosure. As shown in FIG. 4, the housing 105 includes for each end cap 110, an attachment (or vent) hole 305 and a recess 325. The recess 325 is sized to accommodate the connector 135 and the attachment hole/vent 305 is sized to accommodate (e.g., in a friction fit engagement) a protrusion 405 arranged on the connector 135 of the end cap 110. As should be understood, the protrusion 405 (and the attachment hole 305) may be sized to allow the protrusion to be selectively removed from the attachment hole 305 to allow the end cap 110 to be detached from the housing 105 (e.g., for cleaning purposes). In the exemplary embodiment of FIG. 4, the protrusion 405 has an oblong shape corresponding to the attachment hole/vent 305. The disclosure, however, contemplates the protrusion 405 may have other shapes, such as circular, quadrilateral, polygonal, etc. (in correspondence with the attachment hole 305). Additionally, while the exemplary embodiment includes a single protrusion 405 for each end cap 110, the disclosure contemplates each end cap 110 may have more than one protrusion 405 (in correspondence with the attachment hole(s) 305).

As also shown in FIG. 4, the housing 105 includes an end flange 320 on each end of the housing 105. Each end flange 320 is sized to accommodate an end cap 105 on the external surface thereof. As shown in FIG. 4, each end flange 320 includes a protruding lip 315. The protruding lip 315 is sized to engage with a corresponding depression 410 on an inner surface of the end cap 110. While with the exemplary embodiment of FIG. 4 includes a protrusion on the flange and a corresponding depression on the end cap, the disclosure contemplates that in embodiments, the end cap may have a protrusion and the flange may have a corresponding depression.

In embodiments, one or both of the end flanges 320 may include a recessed region 330 (e.g., a concavely-shaped recessed region) for providing access (e.g., griping access) for a user's fingers on each side (e.g., the front and the back) of the end flange 320. The recessed regions 330 increase an amount of exposed instrument so that a user may more easily grip the musical instrument 310 when removing the instrument 310 from the instrument case 100. As shown in FIG. 4, the recessed regions 330 may be provided on a same end of the housing 105 as the bearing 115 defining an eyelet 130. Thus, if a user is carrying the instrument case 100 in a hanging manner using the bearing 115 (e.g., by passing a hook or a carabiner through the eyelet 130), the recessed regions 330 are provided on the “upper” end of the instrument case. As shown in FIG. 4, the recessed region 330 does not extend beyond the protruding lip 315. In such a manner, as described further below, when the end cap 110 is closed on the flange 320, the protruding lip 315 engages with the corresponding depression 410 on the interior of end cap 110 to seal the end of the instrument case 100.

As shown in FIG. 4, the housing 105 includes two projections 150 that extend from each end of the housing 105 (from positions inward of the flanges 320), and an attachment loop 120 extending between the two projections 150 defining the slot 125 on the back side of the case 100. In accordance with aspects of the disclosure, a user may carry the instrument case 100 by passing their belt or bandolier, for example, through the slot 125.

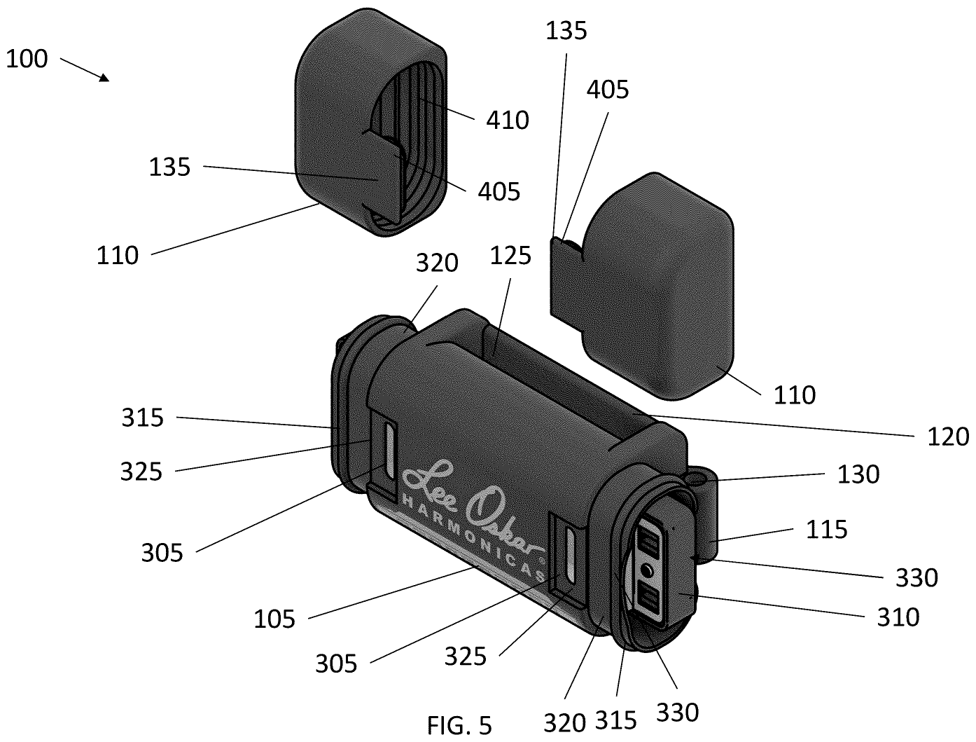

FIG. 5 shows another perspective view of the instrument case 100 with both end caps 110 removed and an instrument 310 arranged therein in accordance with aspects of the disclosure. As shown in FIG. 5, the housing 105 includes for each end cap 110, an attachment hole/vent 305 and a recess 325. The recess 325 is sized to accommodate the connector 135 and the attachment (or vent) hole 305 is sized to accommodate (e.g., in a friction fit engagement) a protrusion 405 arranged on the connector 135 of the end cap 110.

As also shown in FIG. 5, the housing 105 includes an end flange 320 on each end of the housing 105. Each end flange 320 is sized to accommodate an end cap 105 on the external surface thereof (e.g., in a friction fit). As shown in FIG. 5, each end flange 320 includes a protruding lip 315. The protruding lip 315 is sized to engage with a corresponding depression 410 on an inner surface of the end cap 110. While with the exemplary embodiment of FIG. 5 includes a protruding lip on the flange and a corresponding depression on the end cap, the disclosure contemplates that in embodiments, the end cap may have a protruding lip and the flange may have a corresponding depression. Also, while with the exemplary embodiment of FIG. 5 includes one protruding lip on the flange and one corresponding depression on the end cap, the disclosure contemplates that in embodiments, the end flange may have more than one protruding lip and the end cap may have a corresponding number depressions. Additionally, while with the exemplary embodiment of FIG. 5, the protruding lip 315 extends around the entire perimeter of the end flange 320, the disclosure contemplates that in embodiments, the protruding lip may extend around only portions of the perimeter. Furthermore, while in embodiments, the protruding lip 315 may be formed as a part of the end flange 320, in other contemplated embodiments, a seal (e.g., an O-ring) may be used instead of the protruding lip to seal the instrument case 100. In such an embodiment, the end flange 320 may include a groove sized to accommodate the seal (e.g., an O-ring).

As shown in FIG. 5, in embodiments, one or both of the end flanges 320 may include a recessed region 330 (e.g., a concavely-shaped recessed region) for providing access (e.g., griping access) for a user's fingers on each side of the end flange 320. The recessed regions 330 increase an amount of exposed instrument so that a user may more easily grip the musical instrument 310 when removing the instrument 310 from the instrument case 100. As shown in FIG. 5, the recessed regions 330 may be provided on a same end of the housing 105 as the bearing 115 defining an eyelet 130.

As shown in the side view of FIG. 5, the housing 105 includes two projections 150 that extend from each end of the housing 105 (from positions inward of the end flanges 320), and an attachment loop 120 extending between the two projections 150 defining the slot 125 on the back side of the case 100. In accordance with aspects of the disclosure, a user may carry the instrument case 100 by passing their belt or bandolier, for example, through the slot 125.

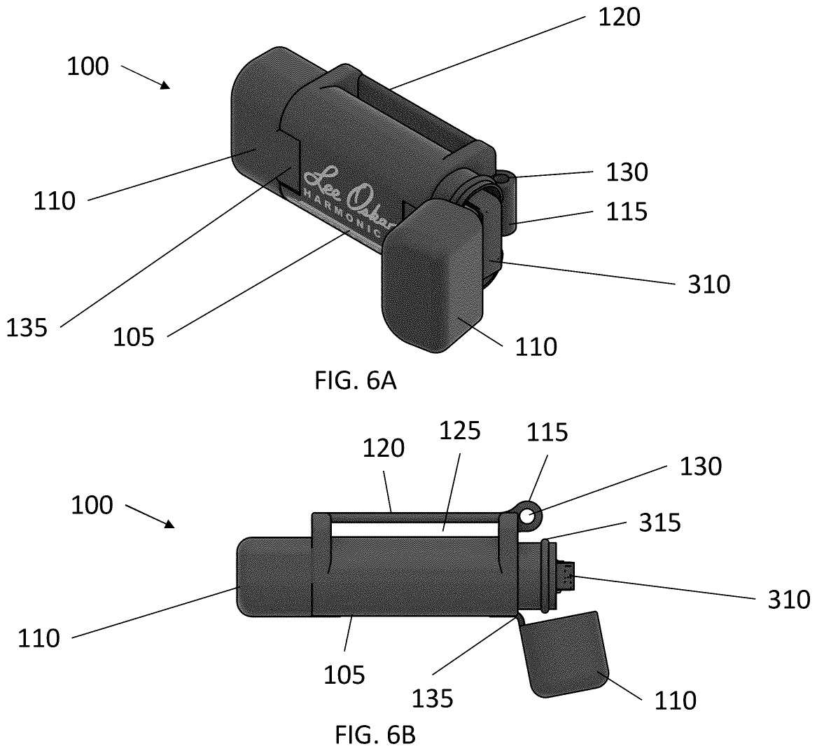

FIGS. 6A and 6B show a perspective view and a top view of an instrument case 100 with one end cap 110 closed and one end cap 110 opened and an instrument 310 arranged therein in accordance with aspects of the disclosure. As shown in FIGS. 6A and 6B, when the end cap is attached and closed, the protrusion (not shown) is accommodated in the attachment hole (not shown), the protruding lip 315 is engaged with the depression (not shown) on the interior of the end cap 110, and the connector 135 is fully accommodated in the recess 325 such that an outer surface of the connecter 135 is flush with (or at least approximately flush with) an outer surface of the housing 105. In such a manner, when each end cap 110 is closed on its respective flange 320, the protruding lip 315 engage with the corresponding depressions (not shown) on the interior of end cap 110 to seal each end of the instrument case 100.

As shown in FIGS. 6A and 6B, in accordance with further aspects of the disclosure, when the end cap 110 is attached and open, the protrusion (not shown) is retained in the attachment hole (not shown) so that the end cap 110 remains securely attached to the housing 105. As shown in FIGS. 6A and 6B, the end cap 110 can (via an elastic deformation of the connector 135) pivotally move away from the end flange 320 to provide user access to the instrument 310. That is, the connector 135 (while retained via connection to the attachment hole) is bendable outward from the recess 325 so that the end cap 110 can be removed from the end flange 320 to provide user access to the instrument 310 (or access to the empty instrument case 100).

In accordance with additional aspects of the disclosure, the end caps 110 remain be attached to the housing 105 via connection with the end flanges 320 while the protrusion of the connector 135 removed from its respective attachment (or vent) hole 305. In such a manner the exposed attachment hole 305 may serve as a vent for the instrument accommodation space.

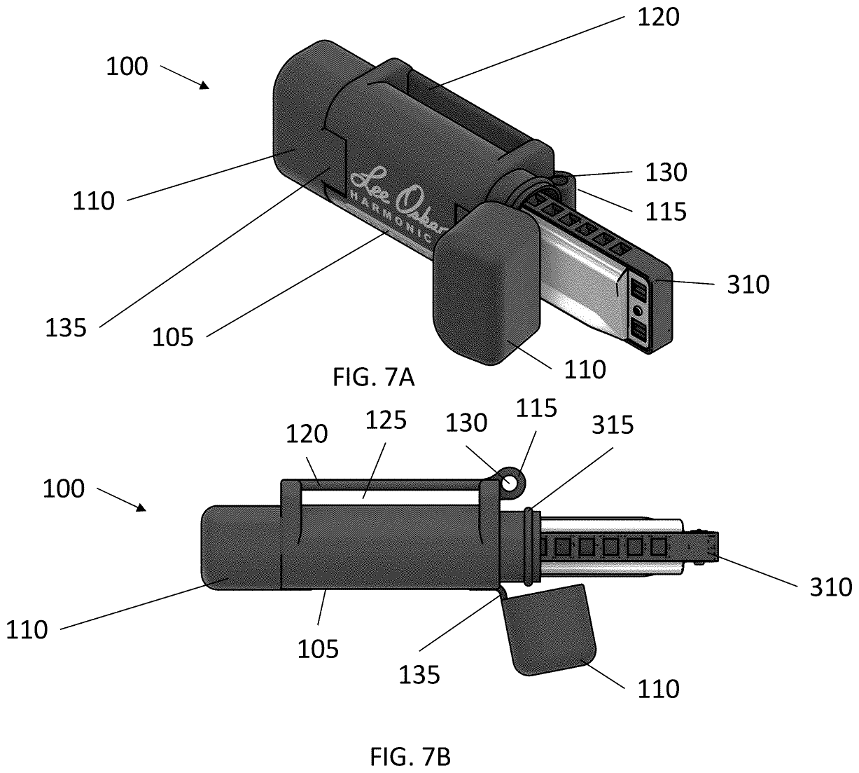

FIGS. 7A and 7B show a perspective view and a top view of an instrument case 100 with one end cap 110 closed and one end cap 110 opened and an instrument 310 partially arranged therein in accordance with aspects of the disclosure. As shown in FIGS. 7A and 7B, when the end cap is attached and closed, the protrusion (not shown) is accommodated in the attachment hole (not shown), the protruding lip 315 is engaged with the depression (not shown) on the interior of the end cap 110, and the connector 135 is fully accommodated in the recess 325 such that an outer surface of the connecter 135 is flush with an outer surface of the housing 105. In such a manner, when each end cap 110 is closed on its respective flange 320, the protruding lip 315 engage with the corresponding depressions (not shown) on the interior of end cap 110 to seal each end of the instrument case 100.

As shown in FIGS. 7A and 7B, in accordance with further aspects of the disclosure, when the end cap 110 is attached and open, the protrusion (not shown) is retained in the attachment hole (not shown) so that the end cap 110 remains securely attached to the housing 105. As shown in FIGS. 7A and 7B, the end cap 110 can pivotally move (via an elastic deformation of the connector 135) away from the end flange 320 to provide user access to the instrument 310. That is, the connector 135 (while retained via connection to the attachment hole) is bendable outward from the recess 325 so that the end cap 110 can be removed from the end flange 320 and pivoted outwardly beyond a sliding range of the instrument 310 in the instrument case 100 to provide user access to the instrument 310 (or access to the empty instrument case 100). In embodiments, the housing 105 and/or the end caps 110 may include one or more internal securing protrusions sized and operable to contact the instrument to arranged therein and stabilize the instrument in the instrument case (e.g., prevent relative displacement within the instrument case 100), e.g., to prevent shaking noise and/or damage to the instrument arranged therein).

In accordance with further aspects of the disclosure, an instrument case 100 having end caps 110 to seal each end of the instrument case 100 provides an improved musical instrument case with the ability to protect an instrument (e.g., a harmonica) from such potentially damaging elements (e.g., water, sand, etc.). By implementing aspects of the disclosure, a user can more easily protect their musical instrument and be more confident of such protection when in the “elements.” Thus, by implementing aspects of the disclosure, greater and more frequent usage of musical instruments in a wider variety of environments can be achieved. For example, by providing a secure instrument case, the fear of exposing an instrument to potentially damaging elements (e.g., water, sand, etc.) is reduced. As such, a user of the instrument case may be less reluctant to carry an instrument (e.g., a harmonica) to such a campfire environment setting—an ideal setting for making music

As such, by implementing aspects of the disclosure, many more people may more readily access and experience playing music, and thereby experience the resulting benefits of music making on their well-being.

In accordance with further aspects of the disclosure, the instrument case is designed to optimize instrument portability, protection, access, and care. For example, the instrument case is easy to carry, with a sturdy carabiner loop and belt loop for secure fastening. Additionally, the instrument case provides protection for the instrument. In embodiments, the housing may be constructed of impact-resistant rigid material (e.g., plastic, metal or composite material) and the end caps may be made of a relatively flexible material (e.g., plastic or rubber material). The instrument case protects against physical damage (e.g., sand, debris) and weather conditions (e.g., rain, humidity, other precipitation). The instrument case includes secure seals to protect from water and sand exposure, and selectively openable vents for airing out at either end (or both ends) of the instrument case.

In accordance with further aspects of the disclosure, the instrument case enables ambidextrous and adaptable access to the instrument. In an exemplary and non-limiting embodiment, the instrument case may be configured and operable to accommodate most 10-hole harmonicas.

In accordance with additional aspects of the disclosure, the materials used for both the housing and the end caps may be easy to clean and sanitize. For example, the material used for the housing and/or the material used for the end caps may be dishwasher-safe. Additionally, the removable end caps allow the accommodation space of the housing to be easily accessed and quickly dried. As such, in accordance with further aspects of the disclosure, the instrument case is designed to optimize instrument portability, protection, access, and care.

While the specification describes particular embodiments of the present disclosure, those of ordinary skill can devise variations of the present disclosure without departing from the inventive concept. For example, as noted above, while the disclosure is described in terms of a harmonica case, the disclosure contemplates the instrument case can be used for other instruments. Additionally, the case could also be used to securely and safely transport other items in need of protection from the elements (such as matches or other items that should remain dry, for example, when camping). Additionally, while the exemplary embodiment includes two openable end caps, the disclosure contemplates an embodiment with only one openable end cap (wherein the other end of the instrument case is formed with the housing

One or more embodiments of the disclosure may be referred to herein, individually and/or collectively, by the term “invention” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising”is interpreted when employed as a transitional word in a claim.

While the disclosure has been described with reference to specific embodiments, those skilled in the art will understand that various changes may be made and equivalents may be substituted for elements thereof without departing from the true spirit and scope of the disclosure. While exemplary embodiments are described above, it is not intended that these embodiments describe all possible forms of the embodiments of the disclosure. Rather, the words used in the specification are words of description rather than limitation, and it is understood that various changes may be made without departing from the spirit and scope of the disclosure. In addition, modifications may be made without departing from the essential teachings of the disclosure. Furthermore, the features of various implementing embodiments may be combined to form further embodiments of the disclosure.

What is claimed is:

1. An instrument case, comprising:
a housing having longitudinal axis, wherein the housing defines an instrument accommodation space and wherein the housing includes an opening at each longitudinal end of the housing; and
end caps operable to close the openings at each longitudinal end of the housing,
wherein the end caps each have a respective connector, wherein the end caps are releasably attached to each end of the housing via the respective connectors.

2. The instrument case of claim 1, wherein the housing further comprises:
a projection extending from each end of the housing; and
an attachment loop extending between the projections,
wherein the projections and the attachment loop define a slot on a side of the instrument case.

3. The instrument case of claim 2, wherein the housing further comprises a bearing defining an eyelet.

4. The instrument case of claim 3, wherein the bearing is connected with one of the projections.

5. The instrument case of claim 1, wherein the housing further comprises for each end cap, an attachment/vent hole and a recess.

6. The instrument case of claim 5, wherein the recess is sized to accommodate the respective connector.

7. The instrument case of claim 5, wherein each end cap includes a protrusion arranged on the connector, and
wherein the attachment/vent hole is sized to fasteningly accommodate the protrusion.

8. The instrument case of claim 7, wherein the attachment/vent hole has an oblong shape.

9. The instrument case of claim 1, wherein the housing further comprises an end flange on each longitudinal end of the housing, wherein each end flange is sized to accommodate one of the end caps on an external surface thereof.

10. The instrument case of claim 9, wherein each end cap includes a depression on an inner surface of the end cap, and
wherein each end flange includes a protruding lip, wherein the protruding lip is sized to sealingly engage with the depression on an inner surface of the end cap.

11. The instrument case of claim 9, wherein at least one of the end flanges includes at least one recessed region for providing gripping access 12. The instrument case of claim 11, wherein each end flange includes a protruding lip, and
wherein the recessed region does not extend longitudinally inwardly beyond a longitudinally outward extent of the protruding lip.

13. The instrument case of claim 11, wherein the housing further comprises a bearing defining an eyelet, and
wherein the at least one recessed region is provided on a same end of the housing as the bearing defining the eyelet.

14. The instrument case of claim 10, wherein when each of the end caps is closed on each of the flanges, the protruding lips engage with the depressions on the interiors of end caps to seal the instrument case from an outside environment.

15. The instrument case of claim 5, wherein when the end cap is closed on the flange while the protrusion is removed from the attachment/vent hole, the attachment/vent hole is operable as a vent for an interior of the instrument case.

16. The instrument case of claim 9, wherein each longitudinal end portion of the housing includes a projection extending therefrom,
wherein the projections are longitudinally inward of the end flanges.

17. The instrument case of claim 5, wherein when the end cap is attached and closed, and the protrusion is accommodated in the attachment/vent hole, the connector is accommodated in the recess such that an outer surface of the connecter is flush with an outer surface of the housing.

18. The instrument case of claim 5, when the end cap is attached and open, the protrusion is retained in the attachment/vent hole so that the end cap remains securely attached to the housing.

19. The instrument case of claim 1, wherein each end cap is operable to swingably move away from the housing via an elastic deformation of the connector to provide user access to the instrument accommodation space.

20. The instrument case of claim 19, wherein the connector is retained via connection to the attachment/vent hole and is bendable outward from the recess so that the end cap can be removed from the end flange and swung outwardly beyond a sliding range for an instrument in the instrument case to provide user access to the instrument or the instrument accommodation space.
